(19) United States
(12) Patent Application Publication
(10) Pub. No.: US 2011/0029822 A1
(43) Pub. Date: Feb. 3, 2011

(54) TRACKING OF JAVA OBJECTS DURING REQUEST PROCESSING

(75) Inventor: Martin Moser, Speyer (DE)

Correspondence Address: SCHWEGMAN, LUNDBERG & WOESSNER/SAP, P.O. BOX 2938, MINNEAPOLIS, MN, 55402, US

(73) Assignee: SAP AG, Walldorf (DE)

(21) Appl. No.: 12/534,686

(22) Filed: Aug. 3, 2009

(51) Int. Cl. G06F 11/30; G06F 9/44

(52) U.S. Cl. 714/45; 717/118; 717/116; 714/E11.179

(57) ABSTRACT

In various example embodiments, a system and associated method to identify an instruction in program code associated with a memory leak in an architecture-neutral, language-based (e.g., Java®) enterprise application platform is disclosed. In an example embodiment of a method, the method comprises performing an allocation trace of program execution and a heap dump of memory used by the program, identifying potentially leaking data structures, identifying objects in the allocation trace associated with the potentially leaking data structures based on unique object identifiers, and identifying locations in the program code where the objects were created.

### TECHNICAL FIELD

The present application relates generally to the field of computer technology and, in a specific example embodiment, to a system and a method of identifying memory leaks in an architectural-neutral language-based environment.

### BACKGROUND

Today's Java®-based enterprise server consists of several thousand technical components that generate hundreds of thousands of data records. Each of the components and data records is capable of generating or storing data. Effective garbage collection in the Java® programming language aids memory management by eliminating unwanted data, also called garbage. However, contemporaneous garbage collection programs do not address all memory problems. For example, memory leaks in Java® are difficult to find, detect, and eliminate. Memory leaks frequently result from design and implementation errors (for example, a reference to an object kept beyond its useful life). Thus, contemporaneous garbage collection can only detect and eliminate typical heap management problems, but are little help in finding memory leaks.

Finding out which combination of object creation and data structure manipulation causes the leak is a task that requires an excellent understanding of the code. Unfortunately, memory leaks are often detected a long time after the code was written and, as such, the problematic code is no longer well understood. Even if the code is well understood, the task of identifying a memory leak is tedious, requiring a great deal of time and good cooperation among several people. Thus, memory leaks often take several months to rectify.

### BRIEF DESCRIPTION OF DRAWINGS

Various ones of the appended drawings merely illustrate example embodiments of the present invention and cannot be considered as limiting its scope.

FIG. 1 is a high-level network diagram of an example enterprise system including an enterprise application platform and a plurality of users of the platform;

FIG. 2 is an example block diagram of example components of the enterprise application platform within the system of FIG. 1;

FIG. 3 is a flowchart illustrating an example method to create an allocation trace and a heap dump that are used to identify memory leaks within a program executed, for example, on the enterprise system of FIG. 1;

FIG. 4A is a flowchart illustrating an example method for identifying instructions in program code associated with memory leaks during execution of the program code;

FIG. 4B is a flowchart illustrating example operations to determine if an object is a candidate for a memory leak within the program;

FIG. 5 is a block diagram of example data structures created during execution of the program code, for example, execution of program code of an enterprise application provided on the enterprise system of FIG. 1; and

FIG. 6 is a simplified block diagram of a machine in an example computing system within which a set of instructions, for causing the machine to perform any one or more of the methodologies discussed herein, may be executed.

### DETAILED DESCRIPTION

The description that follows includes illustrative systems, methods, techniques, instruction sequences or program code, and computing machine program products that embody the present invention. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

Although various example embodiments discussed below focus on administration of Java®-based servers and related environments, the embodiments are given merely for clarity in disclosure. Thus, any type of computing environment, based on an architecture-neutral-language, including various system architectures, are to be considered as being within a scope of the present invention.

In an example embodiment, a method for identifying an instruction in program code associated with a memory leak in a Java®-based enterprise application platform is disclosed. The method includes performing an allocation trace of program execution and a heap dump of memory used by the program, identifying potentially leaking data structures, identifying objects in the allocation trace associated with the potentially leaking data structures based on unique object identifiers, and identifying locations in the program code where the objects were created. More example details for the method are provided herein.

In another example embodiment, a computer system having a Java®-based enterprise application platform is disclosed. The system includes one or more processors within the Java®-based enterprise application platform coupled to a network. An application server and a memory are coupled to the one or more processors. The memory contains a plurality of instructions to implement a method, such as that discussed immediately above. Additional example systems are described in more detail, below.

In another example embodiment, a machine-readable storage medium or computer program product including a set of instructions is disclosed. When the instructions are executed by one or more processors, a method such as the one described above, is performed.

In an example embodiment, the method for identifying instructions in program code associated with a memory leak is deployed in a Java®-based enterprise application platform and, accordingly, is described merely by way of example with reference thereto.

### Overview of an Example Enterprise-System—Adaptable to Inventive Features of Systems and Methods Described

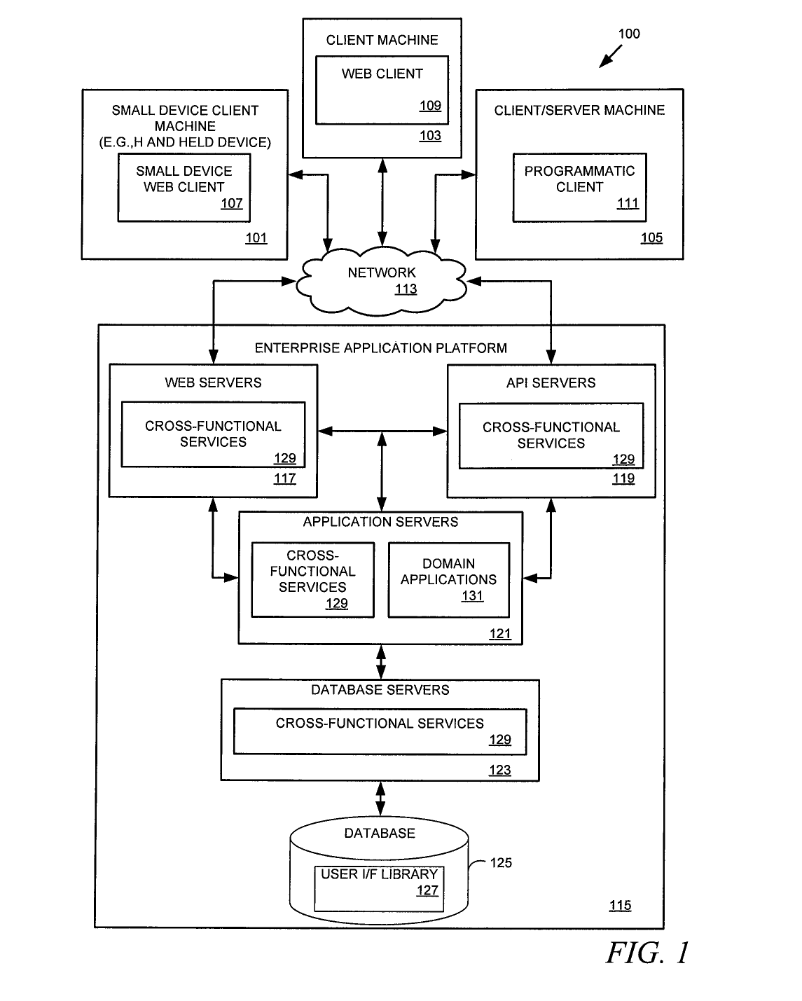

With reference now to FIG. 1, a network diagram depicts an example enterprise-system 100 having client-server architecture in an enterprise environment. The example enterprise-system 100 includes a client machine 103 with a web client 109 (e.g., a browser, such as the INTERNET EXPLORER® browser developed by Microsoft® Corporation of Redmond, Wash., USA), a small device client machine 101 having a small device web client 107 (e.g., a browser without a script engine) and a client/server machine 105 with a programmatic client 111. Each of the client machines 101, 103, 105 is coupled to an enterprise application platform 115, which provides server-side functionality, via a network 113 (e.g., the Internet, an enterprise-based VPN, or a hard-wired enterprise connection) to one or more clients. The enterprise application platform 115 comprises a combination of, for example, machines, software, and firmware. The enterprise application platform 115 can be based upon an integrated technology software-platform such as, for example, SAP NetWeaver® (produced by SAP AG, Walldorf, Germany). Further, while the example enterprise-system 100 of FIG. 1 employs a client-server architecture, inventive features of the present application are of course not limited to such an architecture, and could equally well find application in, for example, a distributed or peer-to-peer architecture system.

Turning specifically to the enterprise application platform 115, one or more web servers 117 and Application Program Interface (API) servers 119 are coupled to, and provide web and programmatic interfaces to, one or more application servers 121. The one or more application servers 121 are, in turn, coupled to one or more database servers 123 that facilitate access to one or more databases 125. The one or more databases can include a user interface library 127. The one or more web servers 117, API servers 119, application servers 121, and database servers 123 host a plurality of cross-functional service modules 129. The one or more application servers 121 further host a plurality of domain application modules 131.

The plurality of cross-functional service modules 129 provides services to both users and processes that utilize the enterprise application platform 115. For example, the plurality of cross-functional service modules 129 provides portal services (e.g., web services), database services, and connectivity to the plurality of domain application modules 131 for users that operate the client machine 103, the client/server machine 105, and the small device client machine 101. Additionally, the plurality of cross-functional service modules 129 provides an environment to deliver enhancements to existing applications and to integrate third party and legacy applications with existing ones of the plurality of cross-functional service modules 129 and the plurality of domain application modules 131.

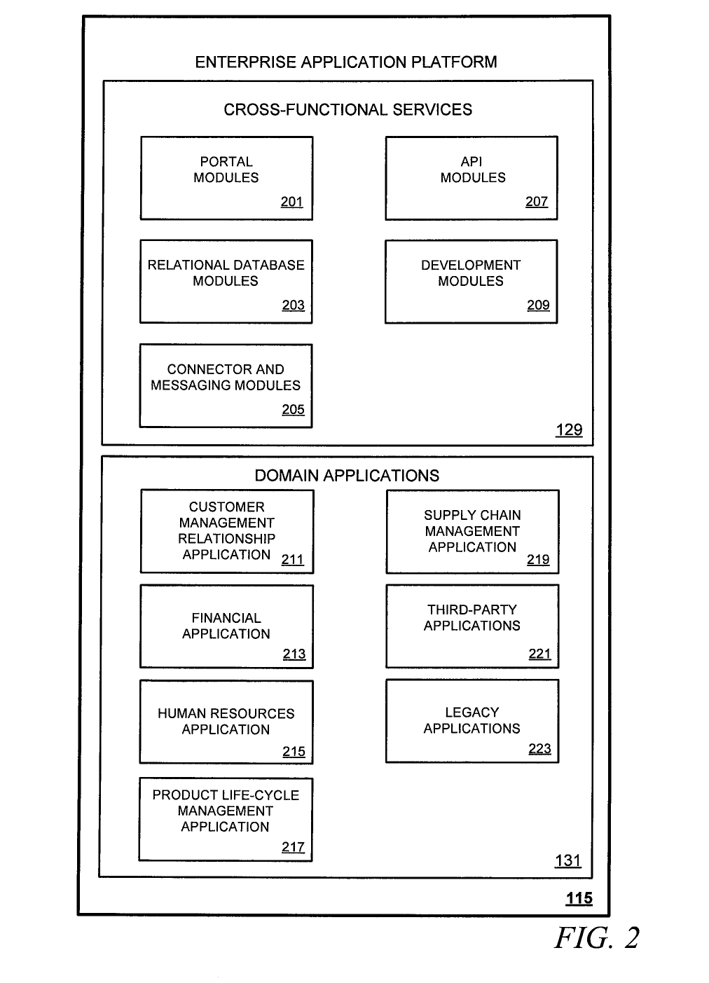

Referring now to FIG. 2, a block diagram of example components of the enterprise-system 100 of FIG. 1 is illustrated. In particular, example components of the cross-functional service modules 129 and the domain application modules 131 are shown. In a specific example embodiment, the plurality of cross-functional service modules 129 each include portal modules 201, relational database modules 203, connector and messaging modules 205, API modules 207, and development modules 209. As will be recognizable to a skilled artisan, each of the modules can be implemented in hardware, software, or firmware. Further, various modules can be combined.

The portal modules 201 enable a single point of access to the plurality of cross-functional service modules 129 and domain application modules 131 for the client machine 103, the client/server machine 105, and the small device client machine 101 (see FIG. 1). The portal modules 201 can process, author, and maintain web pages that present content (e.g., user interface elements and navigational controls) to a user. In addition, the portal modules 201 may enable user roles, a construct that associates a role with a specialized environment utilized by a user to execute tasks, utilize services, and exchange information with other users and within a defined scope. For example, the role may determine the content that is available to the user and the activities that the user may perform. The portal modules 201 can include a generation module, a communication module, a receiving module, and a regenerating module (albeit not shown explicitly). Further, the portal modules 201 comply with web services standards or utilize a variety of Internet technologies including Java, J2EE, Advanced Business Application Programming Language (ABAP) and Web Dynpro (both available from SAP AG, Walldorf, Germany), XML, JCA, JAAS, X.509, LDAP, WSDL, WSRR, SOAP, UDDI, and Microsoft® .NET (each known independently in the art).

The relational database modules 203 provide support services for access to the one or more databases 125 including the user interface library 127 (see FIG. 1). The relational database modules 203 provide support for object relational mapping, database independence, and distributed computing. The relational database modules 203 are utilized to add, delete, update, and manage database elements. In addition the relational database modules 203 comply with database standards or utilize a variety of database technologies including SQL, SQLDBC, Oracle, MySQL, Unicode, JDBC (each known independently in the art).

The connector and messaging modules 205 enable communication across different types of messaging systems utilized by the plurality of cross-functional service modules 129 and domain application modules 131 by providing a common messaging application processing interface. The connector and messaging modules 205 enable asynchronous communication on the enterprise application platform 115.

The API modules 207 enable development of service-based applications by exposing an interface to existing and new applications as services. Repositories are included in the platform as a central place to find available services when building applications.

The development modules 209 provide a development environment for the addition, integration, updating, and extension of software components on the enterprise application platform 115 without impacting existing ones of the plurality of cross-functional service modules 129 and domain application modules 131.

With continuing reference to FIG. 2 and turning now to the plurality of domain application modules 131, a customer relationship management application module 211 enables access to, and facilitates collecting and storing of, relevant personalized information from multiple data sources and business processes. For example, enterprise personnel that are tasked with developing a buyer into a long-term customer may utilize the customer relationship management application module 211 to provide assistance to the buyer throughout a customer engagement cycle.

Enterprise personnel may also utilize a financial application module 213, along with various business processes, to track and control financial transactions within the enterprise application platform 115. The financial application module 213 facilitates execution of operational, analytical, and collaborative tasks associated with financial management. Specifically, the financial application module 213 enables performance of tasks related to financial accountability, planning, forecasting, and managing the cost of finance.

A human resource application module 215 may be utilized by particular enterprise personnel and business processes to manage, deploy, and track all enterprise personnel or certain subsets thereof. Specifically, the human resource application module 215 enables the analysis of human resource issues and facilitates human resource decisions based on real-time information.

A product life cycle management application module 217 enables management of a product throughout a life-cycle of the product. For example, the product life cycle management application module 217 enables collaborative engineering, custom product development, project management, asset management, and quality management among business partners, both within and outside of the enterprise.

A supply chain management application module 219 enables monitoring of performances observed in supply chains. The supply chain management application module 219 facilitates adherence to production plans and on-time delivery of products and services.

A third party application module 221, as well as a legacy application module 223, can be integrated with the plurality of domain application modules 131 and utilize the plurality of cross-functional service modules 129 on the enterprise application platform 115. As will be recognizable to a skilled artisan and as discussed above, each of the various modules described herein can be implemented in hardware, software, or firmware.

Integration of the Tracking of Java® Objects During Request Processing into the Example Enterprise System

The example applications in the enterprise system 100 of FIGS. 1 and 2 may be Java®-based enterprise applications. Accordingly, the applications may include problematic program code that, when executed, results in memory leaks. It is, however, to be noted that the methods for identifying an instruction in program code associated with a memory leak (e.g., memory leaks resulting from execution of Java®) as described herein are not limited to deployment in an enterprise environment. They may be deployed in any object-oriented software environment.

A memory leak can occur in Java® if a program creates objects, holds them in some data structure, such as, for example, a hash table or list, but does not release the objects even if they are no longer used. Consequently, a data structure holding the objects grows without limit. Eventually, a Java® virtual machine (JVM) may run out of memory, and program execution is terminated with an “OutOfMemory” error.

A growing data structure can be readily identified when searching for a memory leak. Since the data structure holds the leaking objects, identifying growing data structures can also identify an existence of the memory leak. For example, one rich client platform (RCP) application tool, the SAP Memory Analyzer Tool (produced by SAP AG, Walldorf, Germany), analyzes Java® heap dumps. The tool uses the heap dump to heuristically identify suspected memory leaks by counting objects in data structures. However, simply identifying the existence of the memory leak does not indicate how the memory leak occurred (e.g., it does not identify where the object leak occurred in the executable program code). An allocation trace produced by the tool contains no information on which data structure eventually holds the object after the processing of a user interaction has been completed.

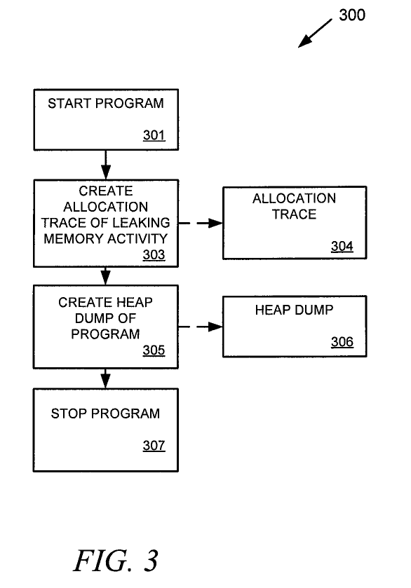

However, in an example embodiment, a method is provided for identifying an instruction in program code associated with a memory leak in a Java®-based enterprise application platform. For example, with reference to FIG. 3, an example method 300 provides for creating an allocation trace 304 and a heap dump 306 that are used to identify memory leaks resulting from program code errors. The allocation trace 304 is a list containing, for each allocated object, the memory address where the object was allocated, the object's class, and the code line of that class where the object was allocated. The heap dump 306 is a list of all objects and classes in memory at the time the dump is performed.

In the method 300, as shown at operation 301, a program suspected of causing memory leaks is executed, for example, on the example enterprise-system 100 of FIG. 1. During program execution at operation 303, the allocation trace 304 of the program is collected. The allocation trace 304 may be written to persistent storage or stored in memory. As mentioned above, the allocation trace 304 provides a record of which objects were created during processing a user interaction with the program and at what locations in the code the objects were created.

The allocation trace can be performed using, for example, the SAP JVM Profiler (produced by SAP AG, Walldorf, Germany) on a request sent from a client to a server. An object identifier is recorded for all objects created in response to the request. Various implementations of the Java® programming language define that each object in memory must have a unique identifier. In a current implementation of the SUN Microsystems® JVM® (which is the standard for a number of other Java® virtual machine implementations), the unique object identifier is a string that consists of a fully qualified class name of an object, an AT sign (“@”), and the object's hash code. Thus, a data defining class of the object can be determined. An address in the memory (heap) where the object is stored is also available (as a hexadecimal number).

After a period of time, but before the next garbage collection cycle occurs, the heap dump 306 is created at operation 305, and the program is then terminated at operation 307. As described in more detail below, the information obtained from the allocation trace 304 and the heap dump 306 may then be processed to identify the code (or portions of code) causing memory leaks.

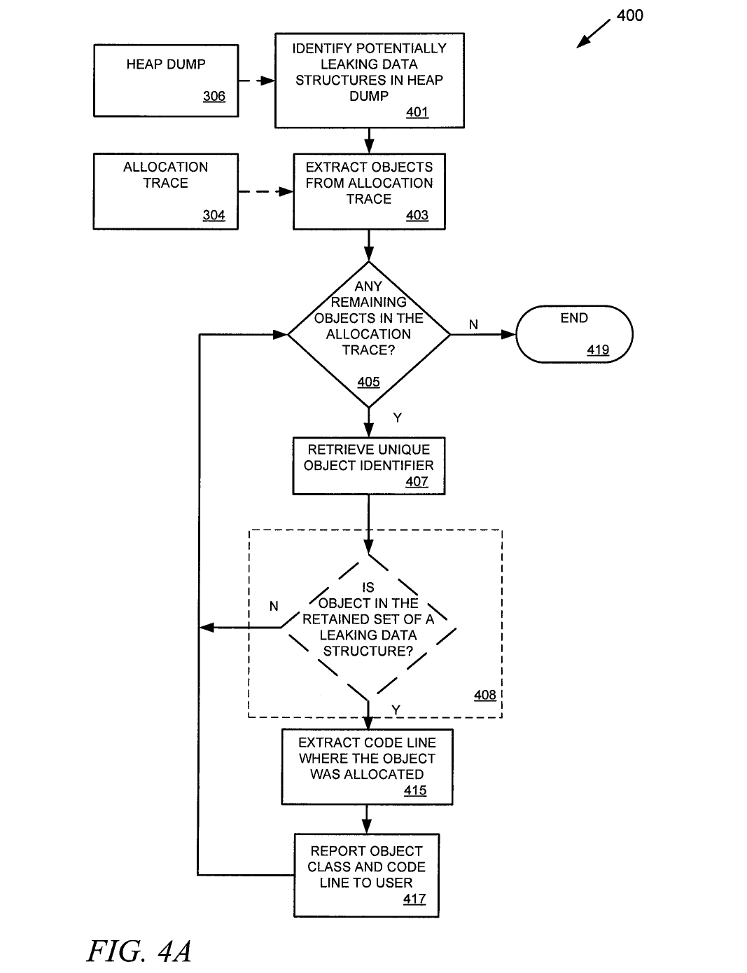

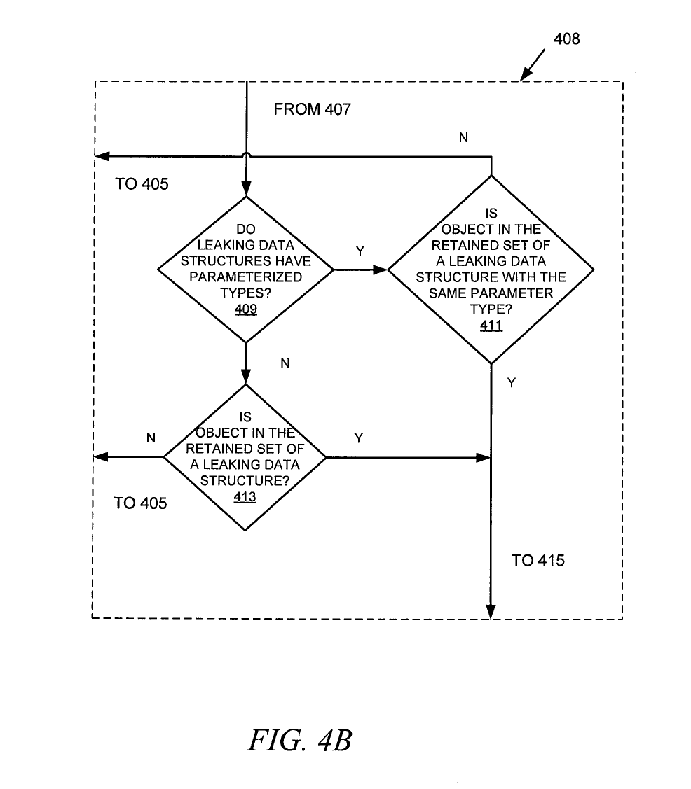

FIG. 4A is a flowchart illustrating an example method 400 for identifying instructions in program code associated with memory leaks during execution of the program code. The method 400 utilizes the allocation trace 304 and the heap dump 306 generated by the method 300 shown in FIG. 3.

At operation 401, the heap dump 306 is searched for leak candidates by looking for “distorted” data structures. The distorted data structures can include very long lists (e.g., lists of objects exceeding a reference number of objects), unbalanced tables, hash tables with a very large number of entries (e.g., a number of entries exceeding a reference number of entries), or other types of similar irregularities. A skilled artisan will recognize that the distorted data structures may be identified by using tools known independently in the art. One such tool discussed above is the SAP Memory Analyzer Tool. Heuristic tests can be performed to determine whether a data structure leaks. For example, memory leakage tests can include monitoring the memory for any consistently increasing usage in conjunction with OutOfMemory errors and degradation in performance of one or more processors on which the system is based, or the use of byte code insertion techniques to track insertions and deletions into the data structure.

Thereafter, as shown at operation 403, all objects instantiated during program execution are extracted from the allocation trace 304 as candidate objects. For each of the candidate objects extracted (see operation 405), its unique object identifier is then retrieved from the allocation trace 304 at operation 407. If there are no remaining candidate objects in the allocation trace 304, the method ends at operation 419.

For each extracted object, as shown at operations 408, a determination is made whether or not the candidate object belongs to the retained set of one of the leaking data structures. The retained set of a data structure is the set of objects that are exclusively reachable by the data structure (see example Table 1, below).

TABLE 1
A candidate object and a potentially leaking hash table in a heap dump.
OBJ 0x004381F0 (sz = 60, trace = 1234, class = java/lang/THread@8b0c38)

| | |
|---|---|
| name | 111afbf8 |
| group | 111af978 |
| contextClassLoader | 1128fa50 |
| inheritedAccessControlContext | 111aa2f0 |
| threadLocals | 111bea08 |
| inheritableThreadLocals | 111bea08 |

An object of type java/util/Hashtable$Entry inner class:

| | | | | | |
|---|---|---|---|---|---|
| 0x4158CD80 | 0x00000000 | 0x00000000 | 0x00000000 | 0x00000000 | 0x00421660 |
| 0x004381C0 | 0x00438130 | 0x00438160 | 0x00421618 | 0x00421690 | 0x00000000 |
| 0x00000000 | 0x00000000 | 0x00438178 | 0x004381A8 | 0x004381F0 | 0x00000000 |
| 0x004381D8 | 0x00000000 | 0x00438190 | 0x00000000 | 0x004216A8 | 0x00000000 |

| | |
|---|---|
| 0x00438130 | [24] OBJ java/util/Hashtable$Entry |

Table 1 shows a portion of an example heap dump 306. In Table 1, an example thread object that was stored at memory address 0x004381F0 may, for example, belong to the retained set of the potentially leaking hash table because its memory address, 0x004381F0, is one of the hash table entries created during the example operation 305.

Returning to decision operation 408, if the candidate object is not within the retained set of any potentially leaking data structure, the method 400 returns to operation 405 to identify if there are any remaining objects in the allocation trace.

However, if the object is in the retained set of a leaking data structure, then as shown at operation 415, the program code line where the object was allocated is extracted (see example Table 2, below). The object class and code line may then be reported to a user (see operation 417). A skilled artisan will recognize that the object may not leak if, for example, the object can later be removed from the data structure by some asynchronous thread. However, this scenario may be unlikely and can be identified by looking closely at the program code.

TABLE 2

```
An allocation trace containing two objects created on line 1442 of
ClassReader.java
TRACE 1234 java/lang/Thread@0x004381F0:
  java.util.zip.ZipEntry.<init> (ZipEntry.java:101)
  java.util.zip.ZipFile$3.nextElement (ZipFile.java:435)
  java.util.zip.ZipFile$3.nextElement (ZipFile.java:413)
  com.sun.tools.javac.jvm.ClassReader.openArchive
(ClassReader.java:1442)
TRACE 1235 java/lang/Thread@0x004582CA:
  java.util.zip.ZipEntry.<init> (ZipEntry.java:101)
  java.util.zip.ZipFile$3.nextElement (ZipFile.java:435)
  java.util.zip.ZipFile$3.nextElement (ZipFile.java:413)
  com.sun.tools.javac.jvm.ClassReader.openArchive
(ClassReader.java:1442)
```

In Table 2, the Thread object at memory location 0x004381F0 (identified previously as a potential leak candidate) is located in the allocation trace 304 with its unique object identifier java/lang/Thread@0x004381F0. The code line where the object was created and the class, line 1442 of ClassReader, is extracted and reported to the user. Thus, the method 400 can be used to identify lines of program code potentially causing a memory leak.

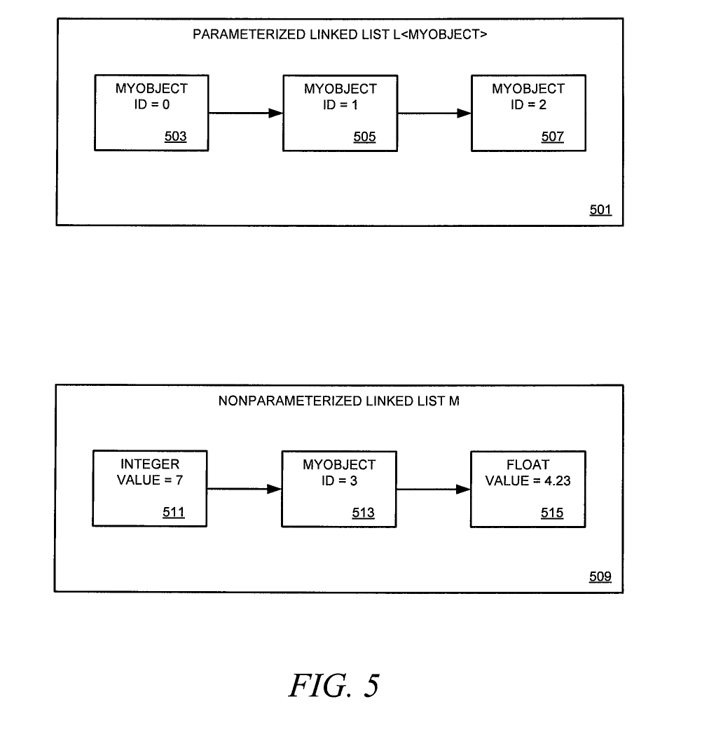

Example details of operations 408 are shown in FIG. 4B. In the illustrated example, the operations in FIG. 4B determine if the retained object, with its unique object identifier, is in a leaking data structure and thus potentially causing a memory leak. As shown at operation 409, in one example embodiment, the leaking data structure is examined to determine whether the data structure is of a parameterized type or non-parameterized type. The distinction between these two types of example data structures is illustrated in FIG. 5.

FIG. 5 illustrates two examples of linked lists. The linked lists are shown to include a linked list L 501 and a linked list M 509. In Java® terminology, the linked list L 501 is of a parameterized type LinkedList <MyObject>, and it is only capable of storing objects of class MyObject, for example, objects 503, 505, and 507. The linked list M 509 is not parameterized (non-parameterized) and therefore can contain objects of any type, such as Integer object 511, MyObject object 513, and Float object 515.

Returning to FIG. 4B, if the leaking data structure is of a parameterized type (see linked list L 501), then at operation 411 the distinction between a parameterized data structure and a non-parameterized data structure is used to filter objects that may be sources of the memory leak. For example, and with reference to FIG. 5, if the potentially leaking data structures are parameterized (see linked list L 501), the object in question is checked to determine whether it is an instance of an object of the parameterized type of any of the potentially leaking data structures. If the object is not of any of the parameterized types, the method 400 returns to operation 405 because the object cannot be the source of the leak (e.g., the potentially leaking data structures only contain objects of class MyObject and the candidate object is not an instance of a MyObject). However, if the object is of the same parameter type, then as hereinbefore described with reference to operation 415 in FIG. 4A, a search is performed to find the object in the heap dump 306. The location in the program code where the object is created can be correlated to a final location of the object in the heap dump 306 by matching the unique object identifier of the object from the allocation trace 304 with the object's unique identifier, discussed above, in the heap dump 306. Therefore, a list of potential memory leaks, both with the program code location where the object was created and the data structure (e.g., the linked list L 501) containing the leaking objects, can be directly located.

Returning to operation 409 in FIG. 4B, if the potentially leaking data structure is non-parameterized (see linked list M 509), in the given example no information may exist on the type of object that is leaking. Thus, all extracted objects in the allocation trace 304 are considered leak candidates. In these circumstances, at operation 413 a determination is made whether or not the candidate object belongs to the retained set of one of the leaking data structures. If so, a search is performed to find the object in the heap dump 306 at operation 415 (shown in FIG. 4A). However, if the holding data structure is not one of the potentially leaking data structures, the method 400 proceeds to operation 405 (see FIG. 4A).

Thus, by performing the operations in the example method 400, each of the objects from an allocation trace can be matched to a potentially leaking data structure. Once the object is related to the data structure and the line where it was created in the program code is determined, a programmer can review the program code to determine if the object is actually a source of the memory leak. The programmer can then take necessary steps to correct any code causing a memory leak.

While various embodiments of the inventive nature of the system and method are described by way of example for tracking of Java® objects during request processing, it will be understood that these embodiments are illustrative only and that a scope of the present disclosure is not limited merely to those described example embodiments. Moreover, the tracking and processing methods described herein may be implemented with facilities consistent with any hardware system or hardware systems either defined herein or known independently in the art using techniques described herein. Many variations, modifications, additions, and improvements are therefore possible.

### Modules, Components, and Logic

Additionally, certain embodiments described herein may be implemented as logic or a number of modules, components, or mechanisms. A module, logic, component, or mechanism (collectively referred to as a “module”) may be a tangible unit capable of performing certain operations and is configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by cost and time considerations.

Accordingly, the term module should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices and can operate on a resource (e.g., a collection of information). As used herein, the term “or” may be construed in either an inclusive or exclusive sense.

### Example Machine Architecture and Machine-Readable Medium

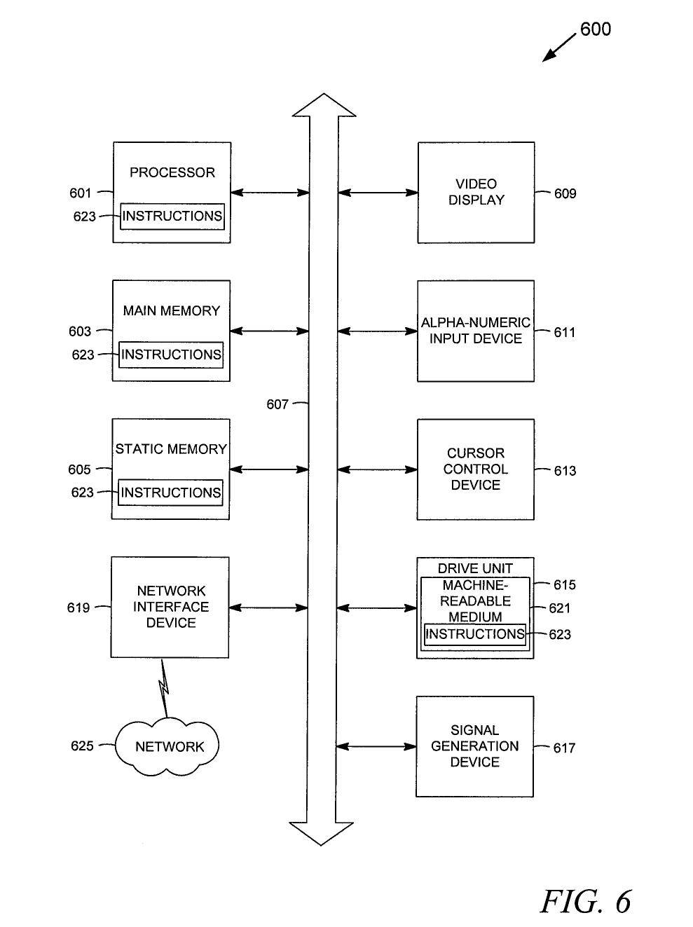

With reference to FIG. 6, an example embodiment extends to a machine in the form of an example computer system 600 within which instructions, for causing the machine to perform any one or more of the methodologies discussed herein, may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 601 (e.g., a central processing unit (CPU), a graphics processing unit (GPU) or both), a main memory 603 and a static memory 605, which communicate with each other via a bus 607. The example computer system 600 may further include a video display unit 609 (e.g., a liquid crystal display (LCD) or a cathode ray tube (CRT)). The example computer system 600 also includes an alpha-numeric input device 611 (e.g., a keyboard), a user interface (UI) navigation device or cursor control device 613 (e.g., a mouse), a disk drive unit 615, a signal generation device 617 (e.g., a speaker), and a network interface device 619.

### Machine-Readable Medium

The disk drive unit 615 includes a machine-readable medium 621 on which is stored one or more sets of instructions and data structures (e.g., software instructions 623) embodying or used by any one or more of the methodologies or functions described herein. The software instructions 623 may also reside, completely or at least partially, within the main memory 603 or within the processor 601 during execution thereof by the example computer system 600; the main memory 603 and the processor 601 also constituting machine-readable media.

While the machine-readable medium 621 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., EPROM, EEPROM, and flash memory devices); magnetic disks such as internal hard disks and removable disks; magneto-optical disks; and CD-ROM and DVD-ROM disks.

### Transmission Medium

The software instructions 623 may further be transmitted or received over a communications network 625 using a transmission medium via the network interface device 619 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. Thus, the Detailed Description is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources.

These and other variations, modifications, additions, and improvements fall within a scope of the present invention is represented by the appended claims. The specification and drawings are, accordingly, to be regarded in an illustrative rather than a restrictive sense.

What is claimed is:

1. A method for identifying an instruction in program code associated with a memory leak, the method comprising:
performing an allocation trace during execution of the program code;
creating a heap dump of a memory including objects created during the allocation trace, each object including a unique object identifier;
identifying at least one potentially leaking data structure in the heap dump; and
for a plurality of objects in the allocation trace,
identifying if an object of the plurality of objects is associated with the at least one potentially leaking data structure based on the unique object identifier; and
identifying a location in the program code where the object was created from the allocation trace.

2. The method of claim 1, wherein the unique object identifier comprises a fully qualified class name of the object.

3. The method of claim 2, wherein the unique identifier further comprises an address in the memory where the object is stored.

4. The method of claim 1, wherein identifying at least one potentially leaking data structure in the heap dump comprises analyzing a plurality of data structures in the heap dump with a memory analyzer tool to identify data structures with distortions.

5. The method of claim 4, wherein the distorted data structures comprises lists of objects exceeding a reference number of objects, unbalanced tables, or hash tables with a number of entries exceeding a reference number of entries.

6. The method of claim 1, wherein identifying when the object of the plurality of objects is associated with the at least one potentially leaking data structure comprises:
determining if the at least one potentially leaking data structure is a parameterized data structure; and
when the object corresponds to a class of the parameterized data structure, identifying the object as being associated with the at least one potentially leaking data structure.

7. The method of claim 6, wherein when the object corresponds to a non-parameterized data structure, identifying the object as not being associated with the at least one potentially leaking data structure.

8. The method of claim 1, wherein the program code is written in the Java® programming language.

9. The method of claim 1, wherein the location in the program code where the object was created is displayed to a user.

10. A computer system to identify an instruction in program code associated with a memory leak, the system comprising:
memory to store the program code, the program code being of an object-oriented computer language; and
one or more processors to:
perform an allocation trace during execution of the program code;
create a heap dump of the memory including objects created during the allocation trace, each object including a unique identifier;
identify at least one potentially leaking data structure in the heap dump; and
for a plurality of objects in the allocation trace,
identify if an object of the plurality of objects is associated with the at least one potentially leaking data structure based on the unique object identifier; and
identify a location in the program code where the object was created from the allocation trace.

11. The system of claim 10, wherein the unique object identifier comprises a fully qualified class name of the object.

12. The system of claim 11, wherein the unique identifier further comprises an address in the memory where the object is stored.

13. The system of claim 10, wherein identifying at least one potentially leaking data structure in the heap dump comprises analyzing a plurality of data structures in the heap dump with a memory analyzer tool to identify data structures with distortions.

14. The system of claim 13, wherein the distorted data structures comprises lists of objects exceeding a reference number of objects, unbalanced tables or hash tables with a number of entries exceeding a reference number of entries.

15. The system of claim 10, wherein identifying if an object of the plurality of objects is associated with the at least one potentially leaking data structure comprises:
determining if the at least one potentially leaking data structure is a parameterized data structure; and
when the object corresponds to a class of the parameterized data structure, identifying the object as being associated with the at least one potentially leaking data structure.

16. The system of claim 15, wherein when the object does not correspond to the parameterized data structure, identifying the object as not being associated with the at least one potentially leaking data structure.

17. The system of claim 10, wherein the program code is written in the Java® programming language.

18. The system of claim 10, wherein the location in the program code where the object was created is displayed to a user.

19. A computer-readable medium embodying instructions which, when executed by a computer causes the computer to:
perform an allocation trace during execution of the program code;
creating a heap dump of a memory including objects created during the allocation trace, each object including a unique identifier;
identify at least one potentially leaking data structure in the heap dump; and
for a plurality of objects in the allocation trace,
identify if an object of the plurality of objects is associated with the at least one potentially leaking data structure based on the unique object identifier; and
identify a location in the program code where the object was created from the allocation trace.

20. A method for identifying an instruction in program code associated with a memory leak, the method comprising:
obtaining an allocation trace performed during execution of the program code;
obtaining a heap dump of a memory including objects created during the allocation trace, each object including a unique object identifier;
identifying at least one potentially leaking data structure in the heap dump; and
for a plurality of objects in the allocation trace,
identifying if an object of the plurality of objects is associated with the at least one potentially leaking data structure based on the unique object identifier; and
identifying a location in the program code where the object was created from the allocation trace.
